(19) United States
(12) Patent Application Publication
(10) Pub. No.: US 2020/0371040 A1
(43) Pub. Date: Nov. 26, 2020

(54) STATIC FULL WIDTH MEASUREMENT SYSTEM

(71) Applicant: Industrial Maintenance Engineering, Inc. d/b/a AIS Gauging,, Terre Haute, IN (US)

(72) Inventor: John Bryant Young, JR., Terre Haute, IN (US)

(73) Assignee: Industrial Maintenance Engineering, Inc. d/b/a AIS Gauging, Terre Haute, IN (US)

(21) Appl. No.: 16/880,868

(22) Filed: May 21, 2020

Related U.S. Application Data
(60) Provisional application No. 62/851,024, filed on May 21, 2019.

(51) Int. Cl. G01N 21/86

(52) U.S. Cl. CPC G01N 21/86; G01N 2021/8416; G01N 2021/869; G01N 2021/8663

(57) ABSTRACT

A full width measurement system includes a frame having a first and second rails. The first and second rails are positioned transverse to a moving sheet of material such that the first and second rails are positioned on opposite sides of the moving sheet. Sources may be positioned along the first rail in a predetermined arrangement across a width of the moving sheet. Each of the sources are configured to emit energy toward the moving sheet in a predetermined pattern. Detectors may be positioned along the second rail in a predetermined alignment with respect to the sources such that each of the detectors detect an energy level from multiple respective sources after the energy from the respective sources has passed through the moving sheet. Controller circuitry is configured to receive signals from the detectors and provide real time measured parameters spanning the width of the moving sheet of material.

### CROSS-REFERENCE TO RELATED APPLICATIONS

The present application claims priority pursuant to 35 U.S.C. § 119(e) to U.S. Provisional Application No. 62/851,024, filed May 21, 2019, which is incorporated herein by reference.

### TECHNICAL FIELD

This disclosure relates to material scanning devices, and more particularly to static full width measurement systems.

### BACKGROUND

Scanning of materials as part of the manufacturing process provides process control and quality control benefits. In addition to dynamic and on the fly control of parameters related to the manufacture of the materials, compliance with manufacturing requirement tolerance and compliance parameters may be monitored and controlled. The materials may be scanned as they are continuously fed past a scanner in real-time during the manufacturing process so that corrections and/or adjustments to the manufacturing process can be automatically implemented, and the resulting changes to the material can be confirmed.

### BRIEF DESCRIPTION OF THE DRAWINGS

FIG. 1 is a block diagram of an example static full width measurement system.

FIG. 2 is an example configuration/implementation of a non-scanning static full-width measurement system.

FIG. 3 is an example display screen for the non-scanning full width measurement system.

FIG. 4 is another example display screen of the static full width measurement system.

FIG. 5 is an example of the process parameter view.

FIG. 6 is a schematic illustrating an example operation of the sources and the detectors in the static full width measurement system.

FIG. 7 is an example overhead view of the frame during operation with the sheet material moving through the measurement aperture.

FIG. 8 is an example configuration of sources and detectors in a frame.

FIG. 9 is an example inclusion detected by the static full width measurement system.

FIGS. 10 and 11 illustrate examples of a sheet material being continuously moved through an example frame between a source and a detector included in the full width measurement system.

FIG. 12 illustrates an example of inclusions in sheet material, which may be identified by the full width measurement system.

FIGS. 13 and 14 are examples of a moving sheet material view of a display screen in the static full width measurement system.

FIG. 15 is another example of a moving sheet material view of a display screen in the static full width measurement system.

FIG. 16 is a schematic of an example frame included in the static full width measurement system.

FIG. 17A and 17B are schematics of different example source configurations within the static full width measurement system.

FIG. 18A, 18B and 18C are schematics illustrating the first and second rails 104 and 106 of a frame in the static full width measurement system.

FIG. 19 is an example collimator forming a source in the static full width measurement system.

FIG. 20 depicts an example of a detector configuration, a source configuration and a cooling system within the static full width measurement system.

### DETAILED DESCRIPTION

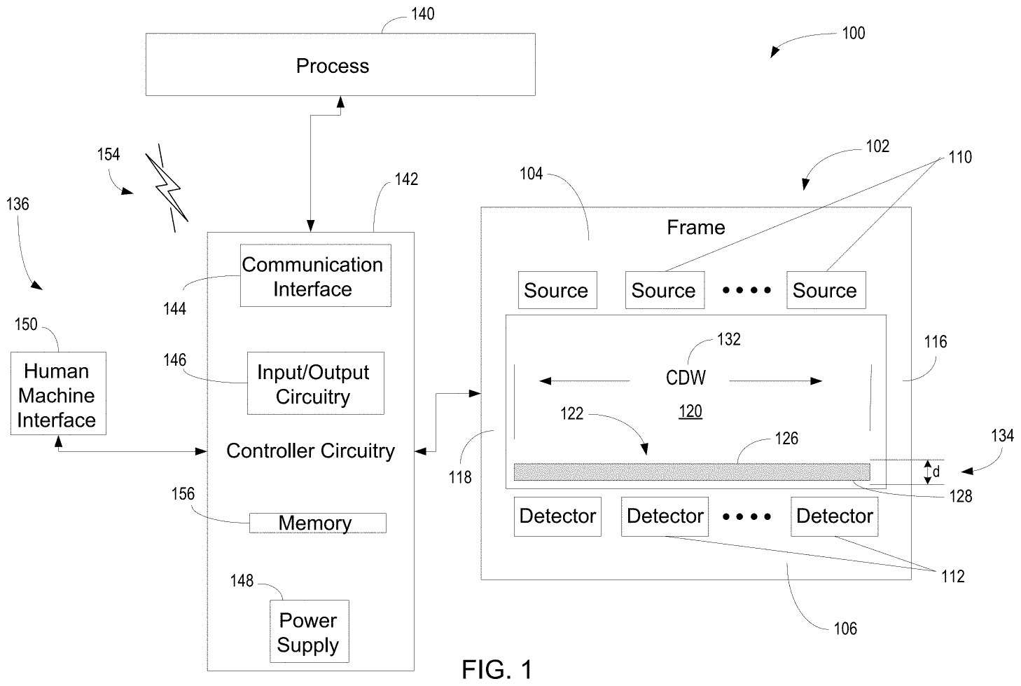

With reference to FIGS. 1-20, the disclosure provides reference to a static full width measurement system that measures a sheet material, such as a moving sheet material that is continuously fed through the system, during a predetermined phase, such as during a phase of a manufacturing process. The system may provide a non-contacting web measurement and process control solution. Web measurement technologies provided by the system may be used in advanced measurement and control of parameters of the sheet material being measured such as: thickness, coat weight, moisture, basis weight, quality, uniformity, consistency, and/or other properties of a manufactured sheet material. The sensor designs included within the system provide best-in-class speed, accuracy and reliability.

FIG. 1 is a block diagram of an example static full width measurement system 100. The system 100 includes a frame 102 having a first rail 104, or top rail, and a second rail 106, or bottom rail. In other examples, the first rail 104 and second rail 106 may be positioned oppositely to what is depicted, transposed, or may be positioned in another respective orientation other than top and bottom. Two or more sources 110 may be positioned along the first rail 104, and two or more detectors 112 may be positioned along the second rail 106. The term “static” as used herein means that the system does not include a moving source or detector. Rather, the sources 110 and detectors 112 are fixedly positioned in the frame 102. The frame 102 may also include a first end 114, or first vertical member, and a second end 116, or second vertical member, forming opposing end columns coupling and rigidly holding the first rail 104 and the second rail 106 such that a measurement aperture 120 is defined by the first rail 104, the second rail 106, the first end 114 and the second end 116. In other examples, the frame 102 may be a “C” shaped frame, instead of an “O” shaped frame such that one of the first end 114 or the second end 116 may be omitted. In other examples, the first rail 104 and the second rail 106 may be mounted on a structure such that the first and the second ends 114 and 116 may be omitted.

A sheet material 122, such as a flat sheet, batt, or other material having opposed relatively planar surfaces may be continuously fed through the measurement aperture 120 in the frame 102. The height and width of the frame 102 may be sized based on the height and width of the sheet material 122, or range of sheet materials 122, that will be fed through the measurement aperture 120. The sheet material 122 may be any structure or material having opposing substantially planar surfaces separated by a substantially uniform thickness, such that a first planar surface 126 is substantially parallel with a second planar surface 128 forming an opposite surface of the sheet material 122. Examples of sheet material 122 include fiberglass, drywall, foam rubber, rubber, paper, steel, aluminum, plastic and the like. The term “substantially planar” and “substantially uniform” relate to three dimensional aspect of the sheet material. For example, a batt of fiberglass being the sheet material 122, may have a relatively higher degree of variation in the planar surfaces 126 and 128, then a sheet of drywall having opposed paper covered surfaces with gypsum based material therebetween forming the sheet material 122.

The first and second rails 104 and 106 may be positioned on opposite sides of the moving sheet material 122. The sources 110 may be positioned along the first rail 104 in a predetermined arrangement across a cross directional width of the moving sheet material 122. Each of the sources 110 may be configured to emit energy toward planar surface 126 (upper surface in the illustrated example) of the moving sheet material 122 in a predetermined pattern. In an example, the sources 110 may be a sensor source, such as a group of x-ray tubes, such as collimator tubes. The sources 110 may be serially positioned across the width of the sheet material 122.

The detectors 112 may be positioned along the second rail 106 in a predetermined alignment with respect to the sources 110 such that each of the detectors 112 detect an energy level from multiple respective sources 110 after the energy from the respective sources has passed through the planar surface 128 (lower surface in the illustrated example) of the moving sheet material 122. The detectors 112 may be arranged as a sensing array of microsensors, such as an array of photodiodes operating as microsensors. The detectors 112 may be serially positioned across the width of the sheet material 122, with each detector including a window material such as aluminum, mylar or similar material through which the energy passes. The window may provide a dust and debris shield for microsensors included in the detector(s) 112. Accordingly, each of the microsensors may detect energy passing through the moving sheet and the window at different predetermined locations across the width of the moving sheet material.

Each of the microsensors may also output a data signal to the microcontroller 142 representative of the energy received from the source 110 at their predetermined location across the width of the moving sheet material 122. The energy received by the detectors 112 may be from a number of the sources 110. Accordingly, the signal output by each of the microsensors may be representative of the total energy received by a respective microsensor. The controller circuitry 142 may compensate for those microsensors in predetermined physical locations where receipt of energy from multiple sources 110 is expected. For example, the controller circuitry 142 may divide the signal by the number of sources 110 from which the respective sensor receives energy.

The quantity of sources 110 and detectors 112 present in the frame 102 may be based on a cross-directional width (CDW) 132 of the sheet material 126 and a depth, or thickness (d) 134 of the sheet material 122. The cross directional width 132 of the sheet material 122 may be the cross-machine direction (CD) width of the sheet material 122 between the first and second end columns 116 and 118. The machine-direction (MD) may be the direction of movement of the sheet material 126 through the measurement aperture 120.

The full width measurement system 100 also includes a control system 136 in communication with the frame 102 and a process 140 wirelessly, by wireline, or some combination thereof. The control system 136 may include controller circuitry 142, communication interface circuitry 144, input/output circuitry 146, power supply 148 and a human machine interface (HMI) 150. The control system 136 may be in communication with the frame 102, the process 140, the power supply 148 and/or the HMI 150, via the input/output circuitry 146 and/or the communication interface 142 and/or another communication path.

Communication with the process 140 may be via a network 154, wireless, and/or hardwired communication paths. The process 140 may be any form of machine or system capable of providing moving sheet material 122 through the measurement aperture 120 in the frame 102. Accordingly, the process 140 may include controllers, such as programmable logic controllers, a distributed control system (DCS), proprietary control and monitoring systems, and/or individual control and or monitoring devices. The process 140 may be a separate standalone independent system which may communicate (send and receive) control signals and/or monitoring signals with the controller circuitry 142. For example, the process 140 may be an extruding process that produces a continuous sheet material 122. In an example, the process 140 may be a fiberglass manufacturing operation in which a continuous sheet material 122 in the form of a bat of fiberglass is moving through the measurement aperture 120 at a predetermined number of feet-per-minute. In other examples, the process may be a drywall manufacturing operation, a foam rubber manufacturing operation, a rubber tire manufacturing operation, a laminates manufacturing operation, or any other type of manufacturing producing continuous sheet material. Accordingly, the system 100 may support industries manufacturing materials such as Pulp and Paper, Plastics, Roofing, Metals, Fiberglass/Nonwovens, Coatings, Wood Products, Textiles, Rubber, and/or Laminates.

The network 154 may be one or more networks including, e.g., the Internet, or other LAN/WAN networks whether private or public, from many different sources. The system 100 may communicate network data via the networks 154 to and from many different destinations in addition or other than the process 140. Examples of sources and destinations include file servers; communication satellites; computer systems; network devices such as switches, routers, and hubs; and/or remote databases; as well as mobile devices connected to the network 154 , e.g., through cellular base stations.

Controller circuitry 142 is configured to receive signals from the detectors and provide real time measured parameters spanning the width of the moving sheet of material. In addition, controller circuitry 142 performs and/or provides over all management and control functionality of the full width measurement system 100, as described herein. Also, the controller circuitry 144 may include the most advanced algorithms for both machine direction (MD) and cross direction (CD) controls. The controller circuitry 142 may also include system processing and computing hardware such as a GUI computer workstation in communication with a Gemini™ computing platform configured to process sensor data.

For the sake of brevity and clarity, controller circuitry 142 is shown as, generally, being operatively coupled to any or all of the frame 102, the process 140, communication interface 144, input/output circuitry 146, power supply 148 and HMI 150. In other words, controller 112 is configured to provide signals and information to, and receive information from (e.g., as feedback), each of the different components of system 100 and the network 154. For example, controller circuitry 142 may send information to the frame 102 to control the operation of the sources 110 and the detectors 112 and received data and information therefrom. As another example, controller circuitry 142 may perform bidirectional communication with the process 140 via the communication interface 144 and/or the input/output circuitry 146 and/or the network 154.

Controller circuitry 142 may include any suitable arrangement of hardware that may include software or firmware configured to perform the techniques attributed to controller circuitry 142 that are described herein. Examples of controller circuitry 142 include any one or more computing systems, computing devices, microprocessors, digital signal processors (DSPs), application specific integrated circuits (ASICs), field programmable gate arrays (FPGAs), or any other equivalent integrated or discrete logic circuitry, as well as any combinations of such components. Thus, there may be any number of independently operating controllers in the system 100 that may or may not be in direct communication with each other. Controller circuitry 142 includes software or firmware and also includes hardware, such as one or more processors, processing units, processing components, or processing devices, for storing and executing the software or firmware contained therein.

In general, a processor, processing unit, processing component, or processing device is a hardware device that may include one or more microprocessors, DSPs, ASICs, FPGAs, or any other equivalent integrated or discrete logic circuitry, as well as any combinations of such components. Although not shown in FIG. 1, controller circuitry 142 may include, or be in communication with, memory 156 configured to store data, logic, instructions, firmware and other digitally storable information. The memory 156 may be any form of storage medium that is other than transitory, and may include any volatile or non-volatile media, such as a random access memory (RAM), read only memory (ROM), non-volatile RAM (NVRAM), electrically erasable programmable ROM (EEPROM), flash memory, and the like. In some examples, the memory may be external to controller circuitry 142 (e.g., may be external to a package in which controller circuitry 142 is housed) and may include or comprise any suitable storage medium, such as a non-transitory storage medium, for storing instructions that can be retrieved and executed by a processor of controller circuitry 142.

In some examples, controller circuitry 142, or any portion thereof, may be an internal component or feature of any of the process 140, communication interface 144, input/output circuitry 146, power supply 148 and HMI 150. In other words, any one or more of the process 140, communication interface 144, input/output circuitry 146, power supply 148 and HMI 150 may include controller circuitry 142, or any feature or characteristic associated with controller circuitry 142 that is described herein.

The communication interface 144 may include transceivers for wired or wireless communication. The transceivers may include modulation/demodulation circuitry, digital to analog converters (DACs), shaping tables, analog to digital converters (ADCs), filters, waveform shapers, pre-amplifiers, power amplifiers and/or other circuitry for transmitting and receiving through a physical (e.g., wireline) medium such as coaxial cable, Ethernet cable, or a telephone line, or through one or more antennas. The system 100 may also support one or more Subscriber Identity Modules (SIMs) to further support data communications over cellular networks. The input/output circuitry 146 may, for example provide an electrical and physical interface connecting the communication interface 144, such as a SIM to other user equipment and hardware. Radio Frequency (RF) transmit (Tx) and receive (Rx) circuitry may handle transmission and reception of signals through one or more antennas, e.g., to support Bluetooth (BT), Wireless LAN (WLAN), Near Field Communications (NFC), and 2G, 3G, and 4G/Long Term Evolution (LTE) communications, RS 232, RS422.

The input/output circuitry 146 may be sensing hardware that includes a graphical user interface, touch sensitive display, voice or facial recognition inputs, buttons, switches, speakers and other user interface elements. Additional examples of the I/O interfaces include microphones, video and still image cameras, temperature sensors, vibration sensors, rotation and orientation sensors, acceleration sensors, headset and microphone input/output jacks, universal serial bus (USB), serial advanced technology attachment (SATA), and peripheral component interconnect express (PCIe) interfaces and connectors, memory card slots, radiation sensors (e.g., infrared (IR) or radio frequency (RF) sensors), and other types of inputs. The I/O interfaces may further include audio outputs, magnetic or optical media interfaces (e.g., a CDROM or DVD drive) or other types of serial, parallel, or network data interfaces. In addition, the input/output circuitry may include analog-to-digital converters (ADC) and digital-to-analog converters (DAC), optical circuits, relays and other signal transmission and receipt circuitry. In an example, the input/output circuitry 146 may include an OPTO 22® system.

The HMI 150 may be any form of computing system, terminal or display in communication with the controller circuitry 142 to provide a user interface for the full width measurement system 100. The HMI 150 may be provided on a platform such as WonderWare™ Factory Suite™ HMI. The HMI 150 provides unparalleled ease of integration with existing controllers and plant network devices. The HMI 150 may include one or more hardware display screens that are driven to display, for example, graphical user interface (GUI) displays. The user interface may accept system parameters, annotation analysis commands, and display on the GUI any type of interface to the system. The interface may visualize, as just a few examples, power, temperature, and other operational parameters of the system. User input capabilities in the graphical user interface may provide keyboard, mouse, voice recognition, touchscreen, and any other type of input mechanisms for operator interaction with the system.

In an example configuration, the HMI 150 may include a superior “HMI” Human Machine Interface using Wonderware InTouch™ and a Microsoft® Windows® Operating System. In addition to User Configurable Screens and Reporting with lock outs, the system 100 may also include capability for complete display customization, Networking Capabilities, Remote and internet viewing/servicing capabilities, Data Exchange through Access, Excel or other Windows programs, Control solutions to optimize profitability, Open Platform Architecture, OPC Interface, VPN Access/Remote Service Diagnostics and/or User configurable displays via the HMI 150.

The power supply 148 may be a power source for the controller circuity 142 and the frame 102. The power supply 148 may include a high voltage power supply providing power to the sources 110 and the detectors 112. Communication within the system, and to devices and systems external to the static full width measurement system 100 may be via a proprietary protocol, or a networking protocol, such as Ethernet.

The system 100 may also include functionality and hardware to support: User Configurable Screens and Reporting; an Open Architecture, such as a 100% Tag-name driven architecture, scalable Hardware and Software, a variety of sensors types, Networking Capabilities, Remote Viewing Capabilities, Internet Viewing Capabilities, Remote Service Diagnostics, Control solutions to optimize profitability, and/or Quality reporting and Data Exchange.

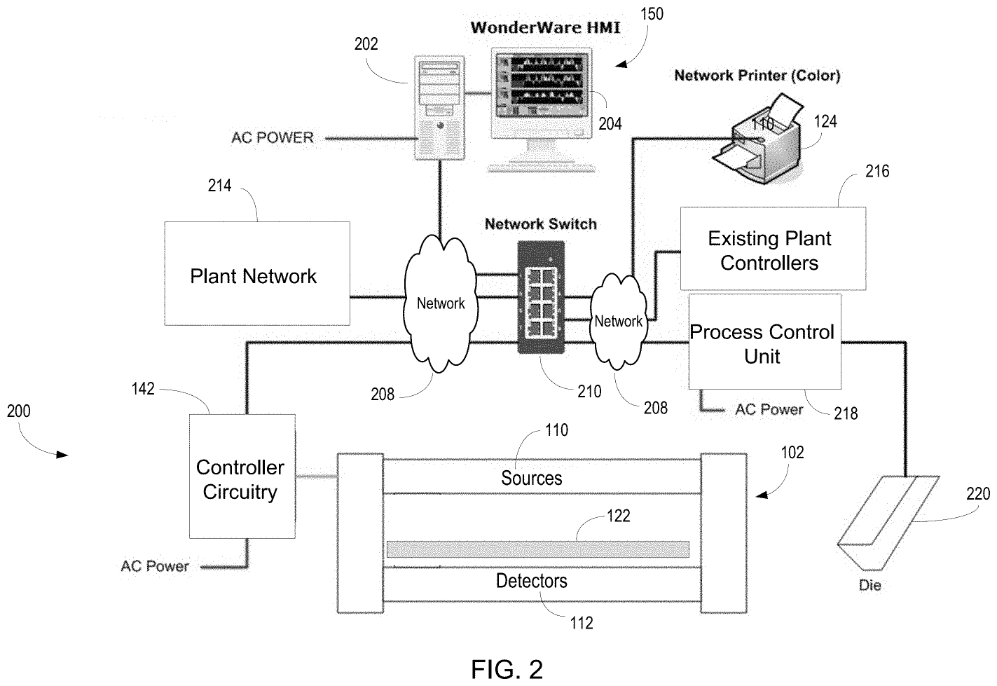

FIG. 2 is an example configuration/implementation of a non-scanning full-width measurement system 200. The system 200 of this example utilizes multiple x-ray sources 110 and detectors (or receivers) 112. The system 200 includes controller circuitry 142 configured to generate a full width measurement of moving sheet material 122 in real time based on the signals received from the detectors 112. In an example, the system 200 provides continuous full-width product measurement with resolution down to 0.1 mm. The measurement data may be displayed with the HMI 150, or some other user interface, in communication with the control circuitry 142 using, for example, 3D analysis software for full operator viewing and control. The example system 200 of FIG. 2 is similar in many respects to the example system depicted in FIG. 1 and described herein. Accordingly, for purposes of brevity, the discussion will focus on differences between the systems of FIGS. 1 and 2 and/or additional features or description. It should therefore be recognized and understood that the features and functionality discussed with regard to FIGS. 1 and 2 are fully compatible, useable together and/or interchangeable, unless otherwise indicated. In FIG. 2, the example HMI 150 may include a computer 202 and at least one display 204. The display 204 may be driven to present to a user or operator real-time variables, display process diagrams and analysis.

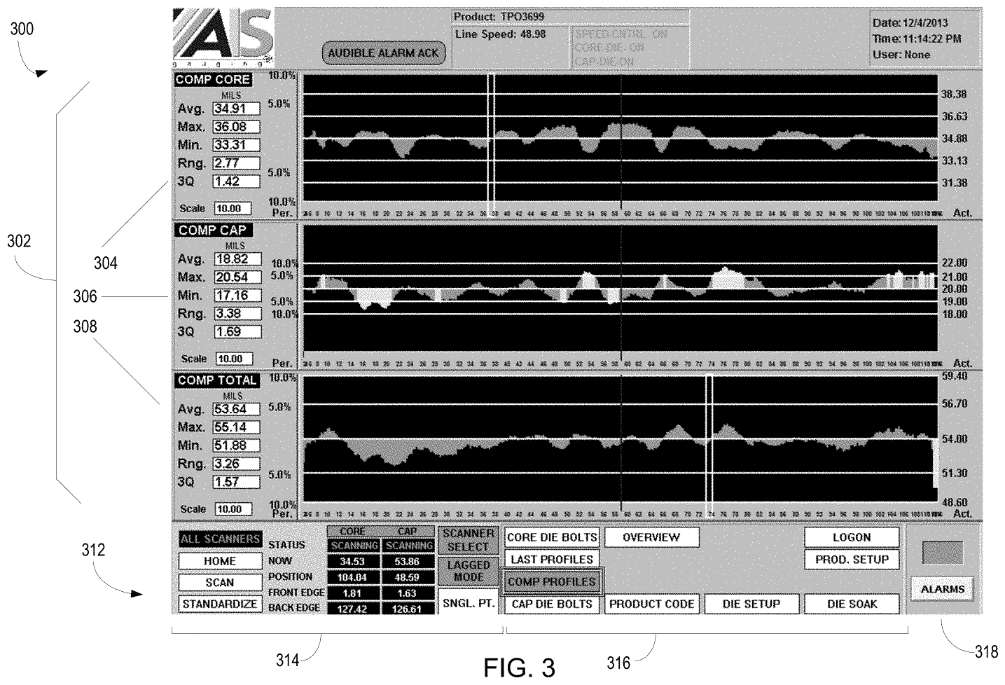

FIG. 3 is an example display screen 300 for the non-scanning full width measurement system 200. The display screen 300 includes graphical display of a process parameter view 302 of three variable parameters 304, 306, and 308 in a cross-machine direction for the corresponding manufacturing process. Each of the parameters 304, 306 and 308 are substantially continuously being updated as the sheet material 122 passes through the measurement aperture 120.

During operation, the controller circuitry 142 may receive data signals from the detectors 112 in a serial stream of data representative of snapshots across the entire width of the moving sheet material 122 such that the controller circuitry 142 generates on the display screen 300 a continuous full sheet image representing a profile of the moving material passing between the sources 110 and the detectors 112. The example display screen 300 also displays average, maximum, minimum, range and 1, 2 or 3 Sigma Cross Direction CD spread for each of the parameters 304, 306 and 308 over predetermined period of time. In the example of FIG. 3, the parameter 304 is comp core, parameter 306 is comp cap, and parameter 308 is comp total. This example display screen 300 is used to indicate that the system 100 may also be used to measure individual layers of products 122 that are then laminated together into a single total product 122. In other examples, different parameters, fewer or greater numbers of parameters, or different arrangements of the parameters may be presented in the display screen 300.

The display screen 300 also includes a dashboard area 312. The dashboard area 312 includes a frame management portion 314 providing status and control of the sources and detectors to scan and continuously measure the moving sheet material. In addition, the dashboard 312 includes a process management portion 316 that allows an operator to manage, monitor and review various process related parameters and information such as reviewing previously measured profiles for the sheet material, enter product codes for the sheet material presently being measured, and the like. In other example, different arrangement and parameters may be displayed. The dashboard area 312, including 314, 316 and 318, may be located anywhere within the display screen 300 and can be configured based on the system configuration and end user requirements.

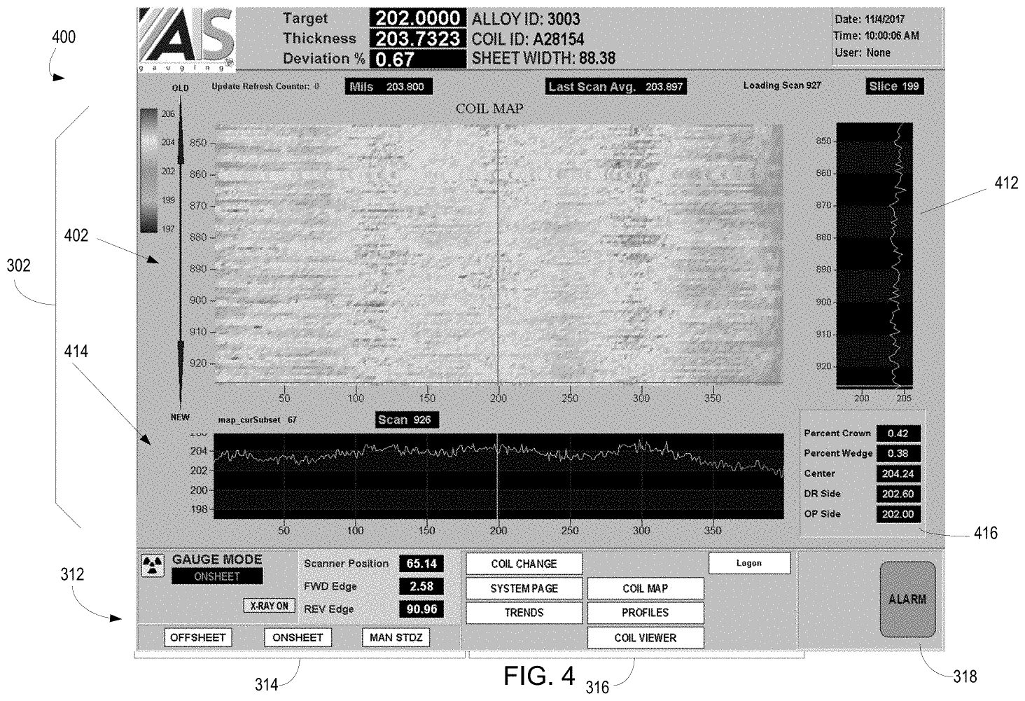

FIG. 4 is another example display screen 400. In this example, the display screen 400 includes the process parameter view 302, the dashboard area 312 having the frame management area 314 and 316, and the alarm area 318. The features and functionality of FIG. 3 are fully applicable, interchangeable and/or useable together with the features of FIG. 4, unless otherwise indicated. Thus, for purposes of brevity, the discussion of FIG. 4 will focus on features and functionality not previously discussed with reference to FIG. 3.

Referring to FIGS. 1, 2 and 4, the process parameter view 302 of this example includes a moving sheet material view 402, a slice view 412 and a scan view 414. The process parameter view 302 may also include a real time process parameters display 416 showing, for example, various accumulated measured values, such as percentages and averages for the measured sheet material, alarms values and other parameters of interest to the operator. In other examples, different parameters may be shown, different arrangements may be used, and different ranges of values may be used.

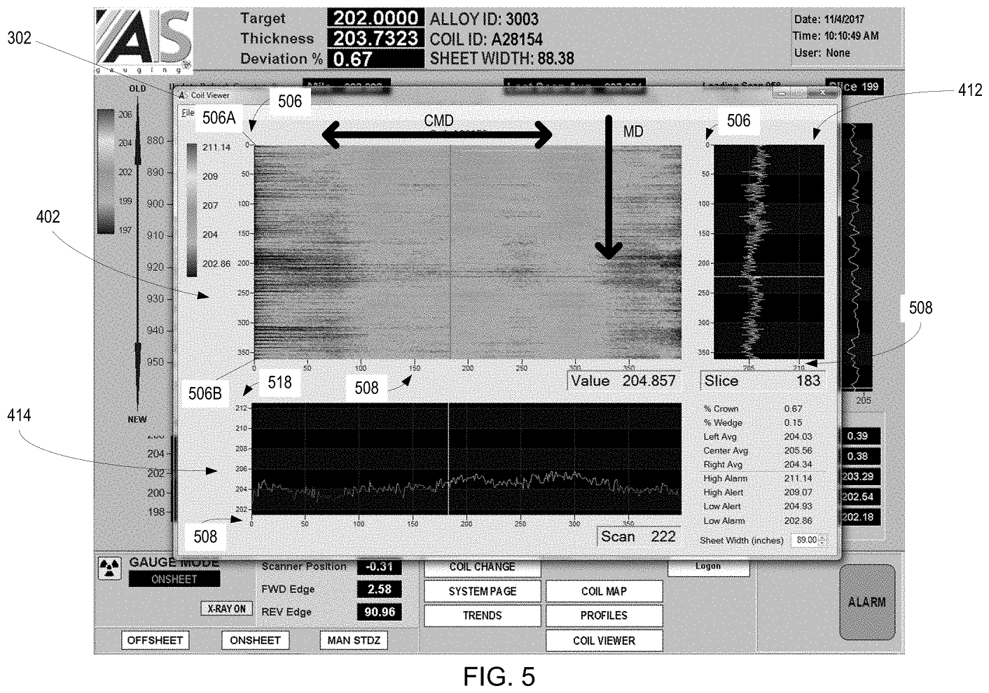

FIG. 5 is an example of the process parameter view 302. The process parameter view 302 may be, for example, a pop-up window accessible from a selection in the dashboard view 312, the process management portion 316, or selecting the process parameter view 302 in FIG. 4. In this example, the process parameter view 302 includes the moving sheet material view 402 showing a top view of the measured moving sheet material in both the cross machine direction (CMD) and the machine direction (MD), as illustrated by arrows. Referring to FIGS. 1-2, 4 and 5, the moving sheet material view 402 may be continuously updated with each snapshot or scan of measurement data from the controller circuitry 142 such that the moving sheet material 122 is displayed as moving down the moving sheet material view 402 in the machine direction as a series of rows 506 of scan data. As a new row of scan data is measured by microsensors (sources 110 and detectors 112) and provided by the controller circuitry 142 to the HMI 150, the sheet material view 402 may add another row 506A of scan data at the bottom of the display and remove a row 506B of scan data from the top of the display to create a “live view” of the sheet material 122 being scanned, as the sheet material 122 moves through the measurement aperture 120.

In FIG. 5, rows 0-355 of scan data are displayed. Each row 506 of scan data may be represented as a series of pixel measurements of the moving sheet material 122 in the machine direction MD, which represents the scan by scan image of the full width measurement of the moving sheet material 122 in the cross direction CD. In an example configuration, each measurement data point, or pixel 508 in the row of scan data may represent scan data provided by a microsensor formed by cooperative operation of the source 110 and the detector 112. Thus, one or more microsensors at physical locations across the width of the sheet material may be represented by a measurement data point or pixel 508 across the width of the moving sheet material 122 in the display. Data output by the microsensors and/or data collection by the controller circuitry 142 may be synchronized in time across the moving sheet material 122 such that each data transmission, and/or data capture is a dataset. The dataset may represent a row 506 across the moving sheet material 122. Accordingly, a series of sequentially received and/or captured datasets represent a length of the moving sheet in a direction of movement across the width of the moving sheet material resulting in data representative of an area of the moving sheet material 122.

In FIG. 5, microsensors 0-400 (or pixels 508) are illustrated. Thus, each pixel 508 in the row 506 of scan data may be a “snapshot” of the moving sheet material 122 showing a visual representation of parameters of interest within the moving sheet material 122. As such, variations in the uniformity of the product may be displayed as inclusions in real time. With each new row 506 of pixels 508, inclusions may grow larger as more microsensors across the cross-machine direction of the moving sheet detect the inclusion and pixels are corresponding displayed, and may shrink as fewer microsensors detect the inclusion. Each of the pixels may be displayed with predetermined shades of color to represent variation in the parameters measured in the moving sheet material. Thus, the HMI 150 may be directed by the controller circuitry 142 to generate a representation of the moving sheet material, and the controller circuitry 142 or the HMI 150 may change a color of an object identified as an inclusion in accordance with the user defined parameters, such as a weight or size of the inclusion.

The slice view 412 of the moving sheet material shows a machine direction view of a particular pixel 508 or group of pixels 508 illustrating variation in process parameters in a particular area of the moving sheet material 122 over a number of rows 506. In the illustrated example, the “slice” of the sheet material 122 being displayed includes rows 506 in a range of 0-355 and pixels 508 in a range of 200-215. The scan view 414 (or profile view) displays a parameter value 518 of each pixel 508 for one or more scans or rows 508. In the illustrated example of the scan view 414, the parameter 518 displayed has units of measurement in a range of 201 to 213, and the pixels 508 in the cross-machine direction are in a range of 0-350. In other examples, different parameters may be shown, different arrangements may be used, and different ranges of values may be used.

In an example implementation, the process parameter view illustrated in FIG. 5 may be an example of historical data for a material, such as historical roll/coil data. The density measurement profile as indicated in the scan view 414 of a material may be imported directly into the HMI 150, or may be displayed on the HMI 150, using the I/O circuitry 146, such as an open platform communication (OPC) included in the I/O circuitry 146. The data may also be imported directly into an external server or database over the network 208 and 214.(FIG. 2)

Referring again to FIG. 2, the configuration of the sources 110 and detectors 112 are illustrated in an “O frame” measurement platform, however, in other examples the system may be deployed with a “C-frame” or an “O-frame” measurement platform. The frame 102, or measurement platform, may be a rigid structure made with rugged steel and epoxy-paint or powder coating. The frame 102 may be configured for any length to accommodate the cross-machine direction width of the moving sheet material 122, and may be about 12″ wide in the machine direction to minimize footprint within the process path. In an example of a frame 102 designed for a 254 cm wide sheet material 122 application, the system 100 may be configured with a predetermined number, such as six sources 110 in the frame 102. Each of the sources 110 may be, for example, rugged oil-filled x-ray tubes emitting energy in the form of x-rays. Different product (material) widths and/or thicknesses may be measured by correspondingly adjusting the frame dimensions and the configuration of the sources 110 and corresponding detectors 112.

In the example system configuration of FIG. 2, the controller circuitry 142 communicates over a network 208 with a network switch 210. Via the network switch 210, the controller circuitry 142 may also bi-directionally communicate with a plant network 214, such as a wide area network or a local area network, existing plant controllers 216, such as a programmable logic controller (PLC), a single loop controller or a distributed control system, a process control unit 218, such as a profile control unit (PCU) controlling a profile of an extruded sheet material 122 and a printer 124. In the illustrated example, the process control unit 218 is controlling a die 220 to manage a thickness of the sheet material 122.

The plant network 214 may provide remote access to the system 200. Accordingly, remote monitoring and/or diagnostics are available via the plant network 214. Feed forward, feedback, parameter monitoring and control between existing plant controller 216 and process control unit 218 and controller circuitry 142 may also occur over the network 208 via the switch 210.

Referring to FIGS. 1-3, during operation, the controller circuitry 142 may output a display image on the display screen 300 indicative of a measurement across a width of a moving sheet of material 122. The sources 110 may be arranged across the width of the moving sheet material 122 and controlled by the controller circuitry 142 to selectively emit energy toward the moving sheet. The detectors 112 may be arranged across the width of the moving sheet 122 to detect a level of the energy emitted by the sources 110 and passing through the moving sheet 122. Each of the detectors 112 may be in electrical communication with the controller circuitry 142 to provide a signal indicative of a measurement of a portion of the width of the moving sheet of material 122. The controller circuitry 142 may direct output the display image on the display screen 300 in accordance with the signal received from each of the detectors 112.

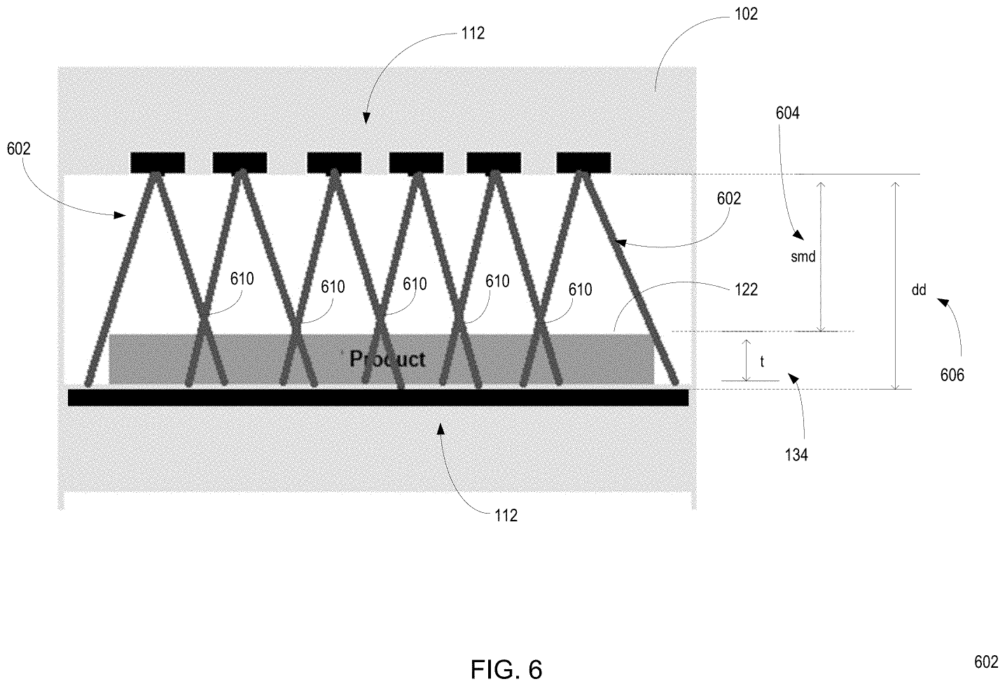

FIG. 6 is a schematic illustrating an example operation of the sources 110 and the detectors 112. During operation, the sources 110 emit an energy pattern 602 for detection by the detectors 112. In an example, the sources 110 emit x-ray energy, and the detectors 112 may be photodiode arrays capable of detecting an energy level of the x-ray energy passing through the moving sheet material 122. Each of the sources 110 emit a predetermined pattern of energy as the energy pattern 602. In the example of FIG. 6, the pattern of the energy beam emitted by respective sources 110 is a cone shaped pattern of increasing diameter with distance from a respective source 110. The sources 110 may be positioned in the frame 102 at a predetermined detector distance (dd) 606 from the detectors 112. In addition, the sources 110 may be positioned a predetermined sheet material distance (smd) 604 from the sheet material 122. Since a thickness of the sheet material 122 is variable, the predetermined sheet material distance 604 is measured from a top surface (or surface facing the sources 110) of the expected maximum thickness (t) 134 (or depth) of sheet material 122), which will be moving through measurement aperture 120.

The predetermined pattern of the energy beams 602 increases in diameter such that the predetermined patterns of the energy beams 602 from respective sources 110 overlap at an overlap point 610 (illustrated as an apex) before the energy beam 602 reaches the sheet material 122 (e.g. before the source material distance 604 is reached). In the example illustrated in FIG. 6, the sheet material 122 is illustrated at a thickness (t) 134 that is a maximum thickness such that the overlap point 610 of the predetermined patterns of energy 602 of respective sources 110 is directly above the sheet material 122 at the source material distance 604. Since all measurements of the sheet material 122 occur after the overlap of the respective predetermined patterns 602, the actual thickness (t) 134 of the moving sheet material 122 does not affect the measurement by the detectors 112. In addition, due to the overlapping predetermined pattern of energy 602 passing through the sheet material 122 and being received by the detectors 112, variation in the thickness (t) 134 of the sheet material 122 does not affect the measurement.

The detectors 112 are positioned a predetermined distance from the moving sheet material 122 such that respective cone shaped patterns of energy 602 emitted from the sources are overlapping at the detectors 112. The moving sheet of material 122 may pass between the sources 110 and the detectors 112 such that the predetermined shaped patterns of energy 602 overlap at a time when the energy reaches the moving sheet material 122.

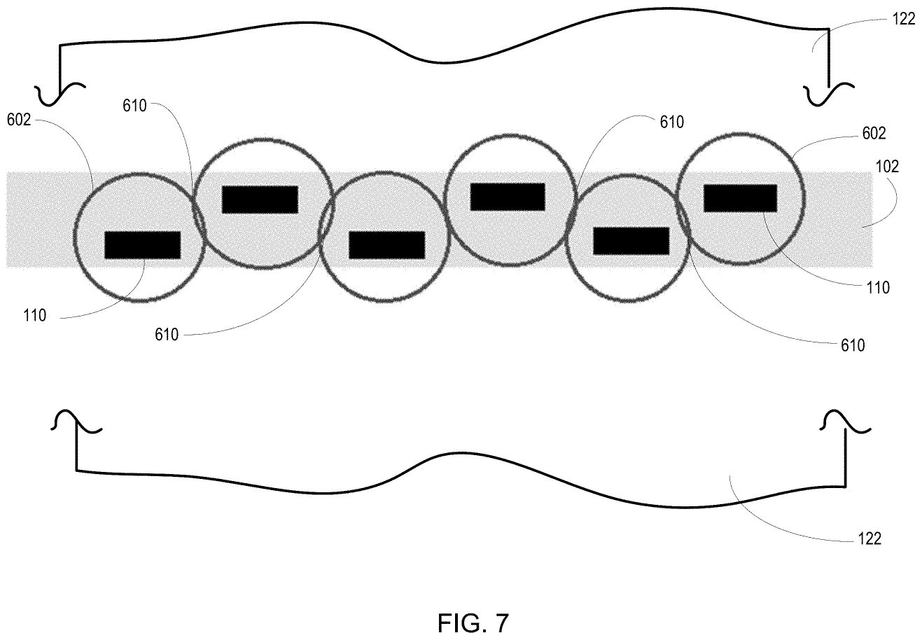

FIG. 7 is an example overhead view of the frame 102 during operation with the sheet material 122 moving through the measurement aperture 120. FIG. 7 shows an example of the overlap points 610 of the predetermined pattern of energy 602 of six sources 110. The overlap points 610 illustrate that there is cross-over of the x-ray energy signals generated by the sources 110 at the point the energy beam generated by the sources 110 reaches the moving sheet material 122. Accordingly, varying portions of the moving sheet material 122 are subject to multiple energy beams from neighboring sources 110. FIG. 7 also illustrates non-overlapping areas of the energy patterns 602. As the moving sheet material 122 increases in thickness (t) 134, the amount of the moving sheet material 122 subject to the predetermined pattern of energy 602 from two different sources 110 increases. Since the detectors 112 (not shown) receive energy beams from two different sources, and the amount of overlap of the predetermined pattern of energy 602 reaching the detectors 112 is known, accuracy of the measurement can be confirmed. The detectors 112 are positioned in predetermined locations in the cross-machine direction across the width of the sheet material 122 to provide at least two different measurements for each of a plurality of predetermined locations across the moving sheet.

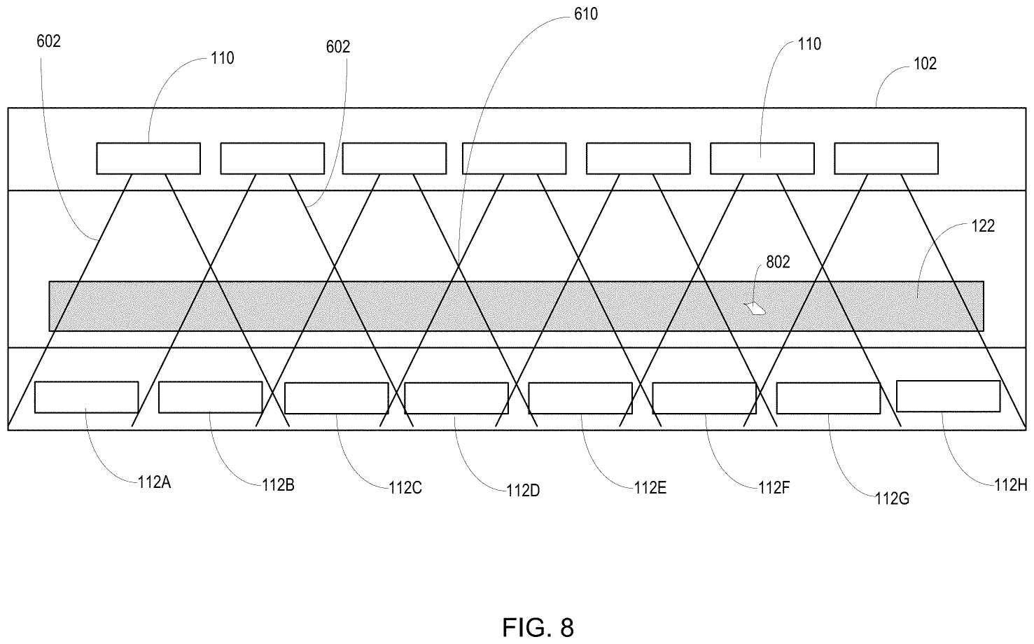

FIG. 8 is an example configuration of sources 110 and detectors 112 in a frame 102. In FIG. 8, the position of the sources 110 relative to the detectors 112 is such that the overlap points 610 of the predetermined patterns of energy 602 are above the moving sheet material 122. In addition, since the predetermined patterns of energy 602 continue to increase with distance from the respective sources 110, the detectors 112B-112G may be completely exposed to energy beams from two different sources 110. Thus, in this configuration, there is full overlap of the predetermined patterns of energy 602 of the detectors 112B-112G. Accordingly, diagnostics, calibration and continuous error checking may be performed by the controller circuitry 142 using the two different energy beams. For example the controller circuitry 142 may compare detected energy beams from two different sources with the same detector. In addition, in this configuration, the controller circuitry 142 may divide by two the signals received from detectors 112B-112G since the detectors 112 are receiving double the amount of energy from the sources 110 compared to the detectors 112A and 112H.

In other examples, the detectors 112 may be only partially exposed to the predetermined pattern of energy 602 (energy beam) from two different sources 110. Since the position and distance of the sources 110 from the detectors 112 are predetermined, the controller circuitry 142 may compensate for those areas of the detectors 112 experiencing receipt of twice the energy level due to receiving two energy beams. For example, the detector 112 may include a certain number of microsensors that are receiving energy from two sources 110, and a certain number of microsensors receiving energy from only one source 110. Since the position of the sources 110 with respect to the detectors 112 is known, those microsensors expected to receive twice the energy level are also known, and the controller circuitry 142 can compensate, such as by dividing the signal by two, of only those microsensors receiving twice the energy, while using the energy measured by the remaining microsensors in the detector 112 without compensation.

Since the controller circuitry 142 receives signals from detectors 112 that are receiving energy from two sources and receives signals from detectors 112 that are receiving energy from only one source, the controller circuitry 142 may use the difference in the signals for calibration, alarming, troubleshooting and other functions. For example, the single source detector signals can be compared to the double source detector signals to confirm accuracy of the measurements.

Measurements by the detectors 112 of the received energy from the sources represent an energy level that is passing through the moving sheet material 122. The level of energy being emitted by a source in the predetermined pattern of energy 602 is known by the controller circuitry 142. Also, the level of energy being received at the detectors 112 without moving sheet material 122 in the measurement aperture 120 is known. Since the energy generated by the sources 110 is being reduced by the sheet material through which the energy passes to reach the detector 112, the controller circuitry 142 may perform calculations to generate parameters representative of variables of interest for the sheet material 122. In addition, the controller circuitry 142 may calibrate the detectors 112 based on the microsensors in the detector 112 which receive energy from a source 110 that has not traveled through the sheet material 122, or microsensors that are covered so as to receive no energy. The microsensors may be covered with a material, such as lead or some other material, through which the energy provided from the sources 110 cannot pass such that some microsensors measure no energy and output a signal indicative of zero energy. Since all the microsensors are subject to generally the same conditions, such as temperature and pressure, the microsensors covered with the material so as to receive no energy may be use for calibration of a lower bound of the output signal range.

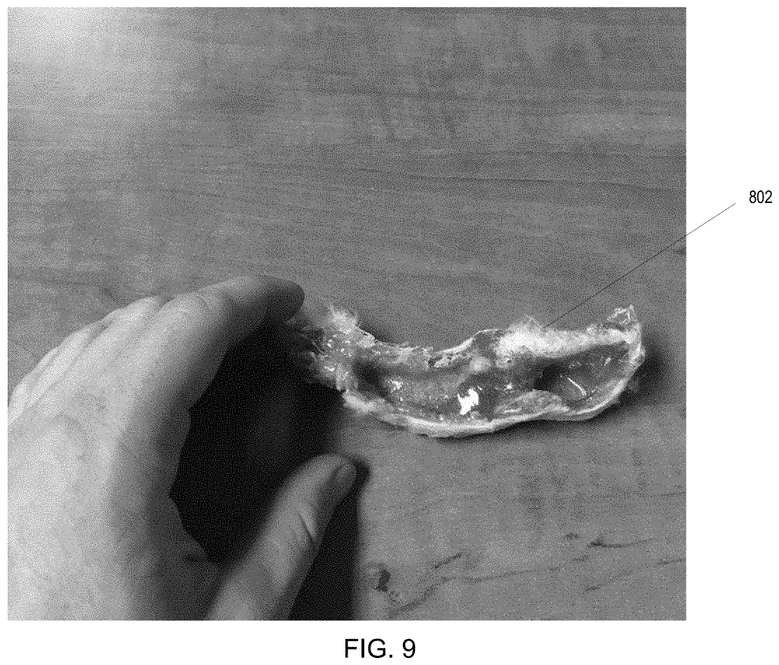

Examples of parameters detectable by the controller circuitry 142 include inclusions 802 in the moving sheet material 122. In addition, the controller circuitry 142 may, for example, detect density of the sheet material 122, width of the sheet material 122, height 134 of the sheet material 122. In addition to detection of inclusions 802 in the moving sheet of material 122, the controller circuitry 142 may also use the measured energy levels received from the detectors 112 to determine a mass, size, weight, and depth of the inclusion 802 within the material. As used herein, the term “inclusion” or “inclusions” describes any undesirable physical object, property or void detected in the moving sheet material 122. For example, when the moving sheet material 122 is fiberglass, an inclusion 802 may be a large dense mass of glass material or binder material present in the moving sheet material 122 as illustrated in the example of FIG. 9. In the example of the sheet material 122 being drywall or foam rubber, the inclusion 802 may be an air bubble, a water bubble, a hole or depression (void), unmixed material or a foreign object. In the example of the moving sheet material being tire tread for a vehicle, the inclusion 802 may be an anomaly in the rubber, or a steel radial tire cord missing or in the wrong position. In other examples, other forms of inclusions may be identified using the signals received by the controller circuitry 142 from the detectors 112.

The controller circuitry 142 may identify at least one of a weight, or a size, or both a weight and a size, of an inclusion included in the moving sheet 122, Alternatively, or in addition, the controller circuitry 142 may identify an inclusion having at least one of a weight, or a size, or a combination thereof, based on a predetermined threshold. Such predetermined thresholds may be user entered values, stored values, or derived values. In some examples, the thresholds may be a single process parameter, or a combination of multiple different process parameters. For example, the threshold may be based only on weight of an inclusion, or may be based on both the combination of weight and size of an inclusion.

The controller circuitry 142 may also use detected energy from two different sources 110 to detect depth of an inclusion present in the moving sheet of material 122. Since the sources 110 and detectors 112 are in different predetermined physical locations a three dimensional physical location in the moving material sheet may be developed by the controller circuitry 142 by obtaining multiple different measurements of an inclusion. For example, a first detector may detect a first energy level received from a first source after passing through an inclusion, and a second detector may detect a second energy level received from the first source after passing through the inclusion. In another example, a detector may a detect a third energy level received from a first source after passing through an inclusion, and the same detector may detect a second energy level received from a second source after passing through the inclusion.

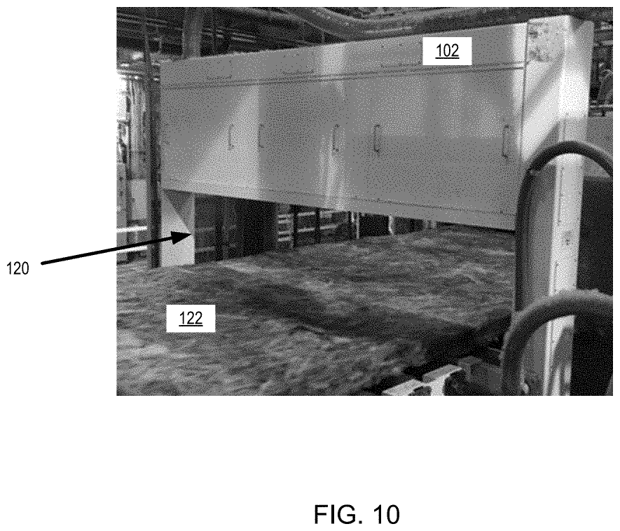

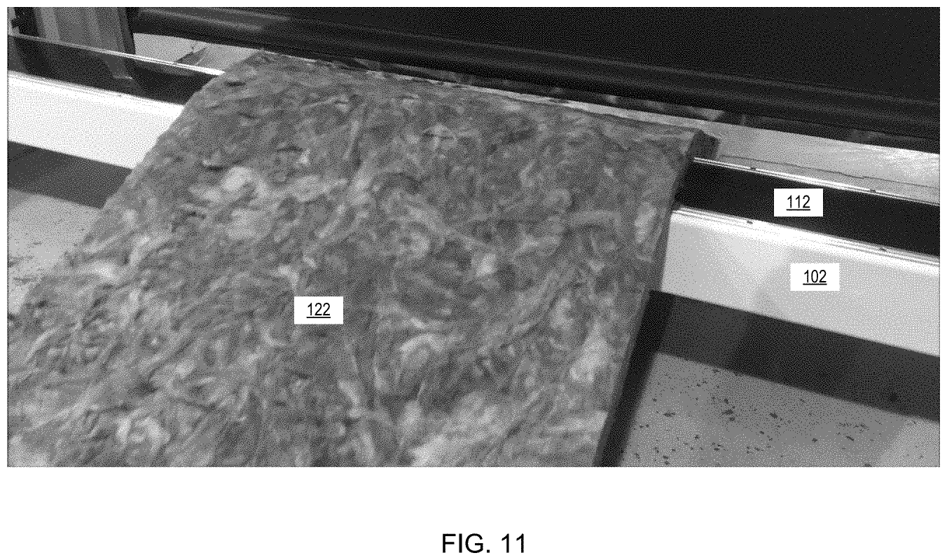

FIGS. 10 and 11 illustrate examples of a sheet material 122 being continuously fed through the measurement aperture 120 of an example frame 102 between a source 110 and a detector 112 included in the full width measurement system 100. In the illustrated example, the sheet material 122 is a web of fiberglass insulation.

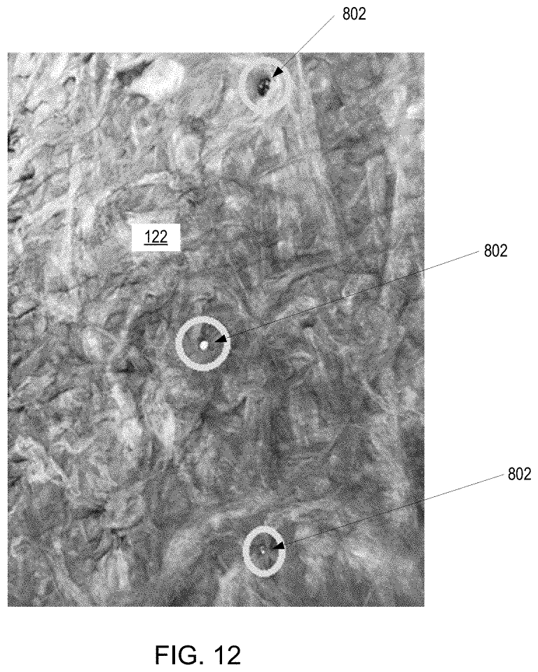

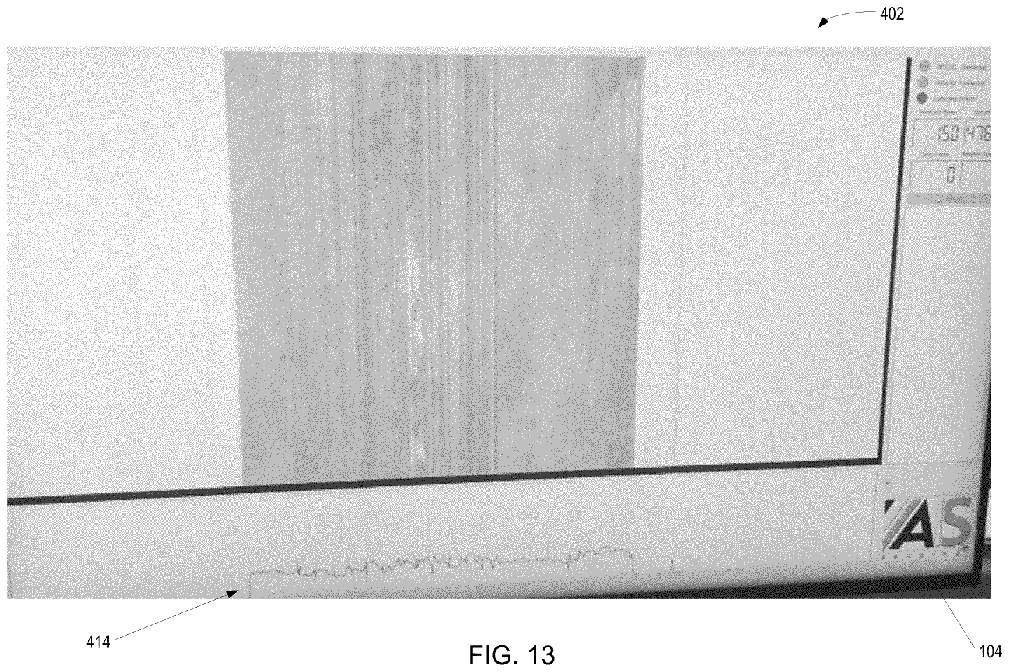

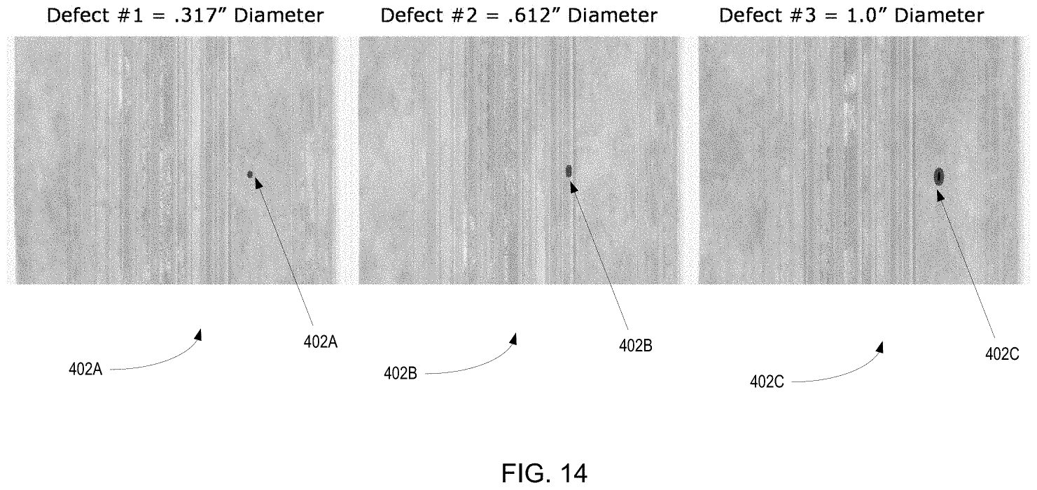

FIG. 12 illustrates an example of inclusions 802 in the sheet material 122, which may be identified by the full width measurement system 100 during continuous static scanning of the sheet material 122. In the illustrated example, the inclusions 802 are anomalies or defects, and holes or voids in the batt of fiberglass illustrated in FIGS. 13 and 14.

FIGS. 13 and 14 are examples of the moving sheet material view 402 of a display screen of a display 204 included in the HMI 150 illustrated in FIGS. 1 and 2. The moving sheet material view 402 of this example is illustrated in FIG. 13 as a real-time measurement of the density of a moving sheet material 122, such as fiberglass. In addition, a scan view 414 of the density of the sheet material 122 is indicated in FIG. 13.

Referring to FIGS. 1-2 and 14, three different moving sheet material views 402A, B and C are shown where a respective different inclusion 802A, B and C is identified by size detected by the detectors 112 and determined by the controller circuitry 142. In addition, in examples, additional parameter information related to the inclusion 802A, B or C may be visually indicated. For example, text and color may be included in the displayed image at the location of the inclusion 802A to represent the size and weight of the inclusion 802A, B and C. In an example text indicating the diameter of each of the inclusions 802A, B and C may be displayed as illustrated. In addition, or alternatively, for example, a visual indicator, such as color coding may be used to indicate that the inclusion 802A, B or C is outside a predetermined threshold value, such as a maximum value, a minimum value or a combination range of values.

The values and/or color coding may be predetermined and user configurable to provide the operator additional insight into whether the inclusions 802A, B or C are of concern. In an example, a combination of size and weight of the inclusion 802C being outside a first threshold may result in the inclusion being visually outlined in red, whereas inclusion 802B may be outside a second threshold and may be indicated as blue, inclusion 802A may be outside a third threshold an may be indicated a yellow, and another inclusion identified but not being outside any of the thresholds may be indicated in green. Note the three inclusions 802A, B and C are identified as defects in real-time as they pass thru the measurement aperture 120 and are added line-by-line to the display as they move through the system.

Accordingly, the full width measurement system 100 may identify defects or inclusions by size and density, with image capturing for viewing and analysis. The system may also be configured for defect alarming. In other examples, any of the parameters measured, calculated or generated by the system may be used to identify inclusions, indications and alarms. Setting of the parameters for identifying, indicating and/or alarming inclusions, or different “kinds” of inclusions, may be user configurable in the system 100 such that user identified categories of types of inclusions may be developed by the user for identification by the system in real-time during operation according the user configured parameters.

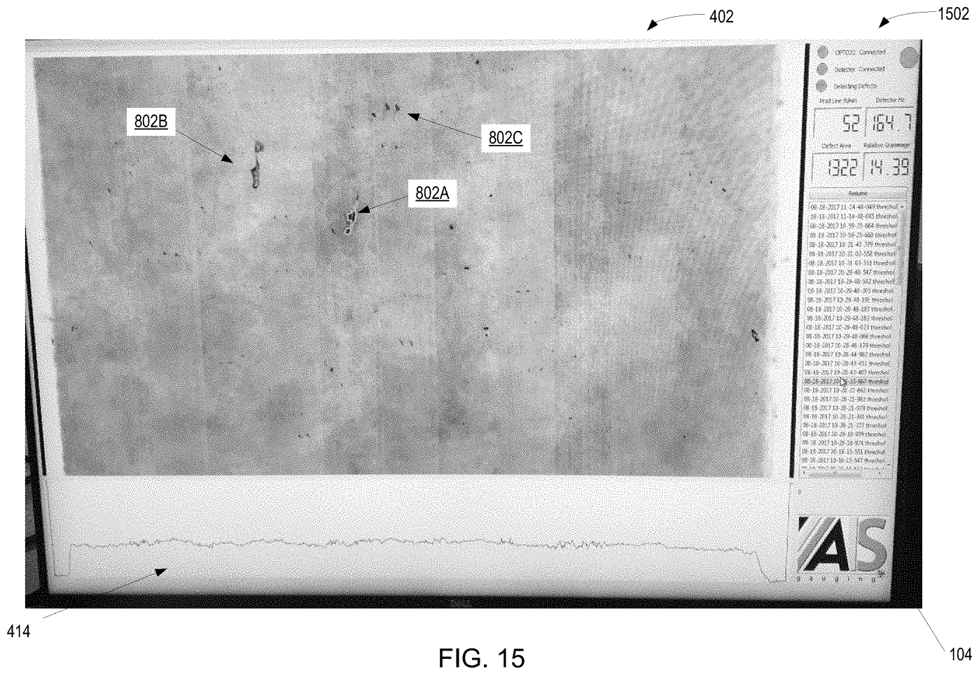

FIG. 15 is another example of the moving sheet material view 402 of a visual display screen of a display 204 included in the HMI 150 as illustrated in FIG. 2. The moving sheet material view 402 of this example illustrates that the defects or inclusions 802 A, B and C may be captured as viewable images using real-time data capture. In addition, the list of defects or inclusions that are captured for viewing, printing and/or historical storage may be displayed along with related parameters in a real-time parameters window 1502. In FIG. 15, inclusion 802A is identified with a color-coded outline and related parameters are provided in the real-time parameters window. Inclusion 802B is not color coded within this display, but would be captured and color coded in a subsequent display. Inclusion 802C would not be captured or color coded since it is not outside the user configured parameters. Alternatively, or in addition, the inclusions may be selectable on the display screen by the user such that once selected, an inclusion 802 A or B will have its corresponding parameters displayed in the real-time parameters window 1502. In addition, a scan view 414 of showing the inclusions along the cross-machine direction of the sheet material may also be provided. In addition to the density of the sheet material 122 being indicated, the selection of the inclusions 802A or B may also be shown.

Referring again to FIGS. 1 and 2, the Graphical User Interface of the HMI 150 may include 3D mapping of the measured materials, as illustrated in FIGS. 13-15. The density measurement profile of the sheet material shown in scan view 414 may be imported into a 3D Color Map tool included in the system FIGS. 4 and 5. This powerful analytical tool provides visual and historical data for analysis and control. The data can be saved locally, or exported directly to an external server or database over the network 154.

Within the full width measurement system 100, placement of the sources 110, such as X-ray tube(s), and detectors 112, such as sensors, placement may be in predetermined locations within the platform provided by the frame 102. The system may also include energy shields, such as X-ray “Narrowing Feed-horn(s)” which may control an amount of energy overlap by managing the predetermined pattern of energy 602. The system may also include multiple sensors, such as dual-PDA's, where each photo-diode is only effected by a single X-ray tube. In some example configurations, the problem of overlapping energy sources may be eliminated. The system may operate with a GUI computer using an HMI such as WonderWare. As previously discussed, the unit may detect defects within the material. The system may also include accurate density measurement with optional 3D Product Color Map 100% of the time.

In example full width measurement systems 100, the design may use multiple sources 110, such as x-ray tubes, and groups of detectors 112 to determine both density and product defects. The number of sources 110 and detectors 112 may be determined by 1) the width of the sheet material 122 to be measured; and, 2) the size of the inclusion to be captured by the system 100. The detectors 112 may be photodiode arrays, whose spacing between components may determine the measurement resolution. The resolution that can be achieved may be limited by the maximum width and speed through the measurement aperture 120 of the moving sheet material 122 being measured. Inclusions, such as defects, may be determined by size and density. A detected inclusion may be captured and stored as an image (picture) by the full width measurement system 100. The system 100 may also output one or more alarms. The full width measurement system 100 configuration may also be modified based on, for example, product thickness, width, product speed, and/or measurement resolution required.

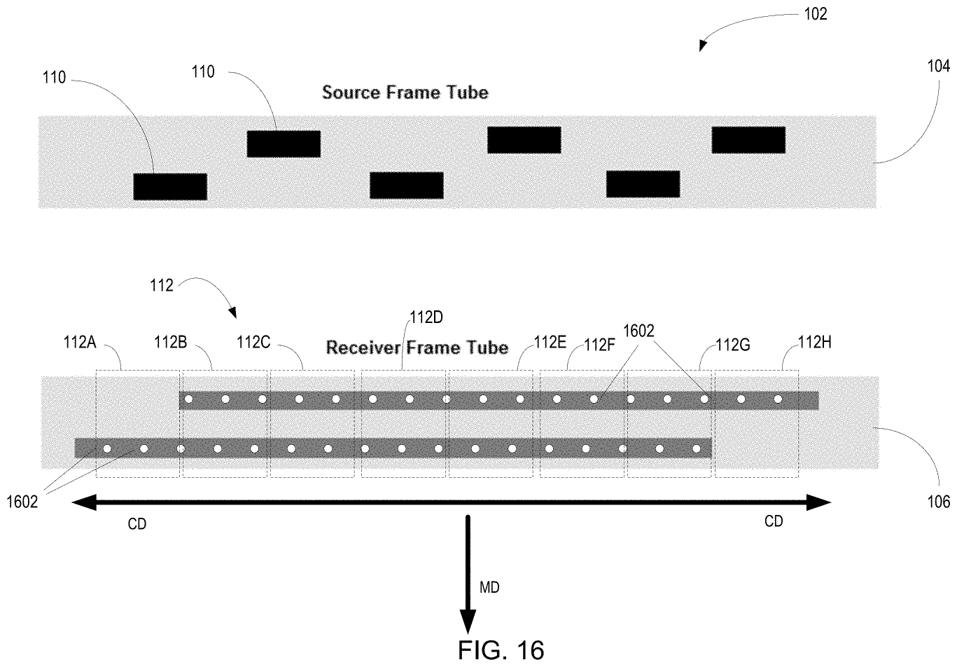

FIG. 16 is a schematic of an example frame 102 having a first rail 104 and a second rail 106. Within the full width measurement system 100, placement of the sources 110, such as X-ray tube(s), in the first rail 104(or source frame tube), and detector 112 (sensor) placement in the second rail 106 (or receiver frame tube) may be in predetermined locations within the frame 102. In FIG. 16, an example overhead view is shown of both the first rail 104 (source frame tube) and the second rail 106 (the receiver frame tube), as well as the initial step to obtaining the overlap, or cross-over effect of the energy beams from the sources 110. As illustrated in this example, the sources 110 are offset or staggered with respect to one another by predetermined distances, both in the machine direction (MD) and the cross-machine direction (CD) as illustrated by arrows. Also, the second rail 106 includes a predetermined number of detectors 112, each of which are sensor arrays.

The detectors 112 may similarly be offset, or staggered in both the machine direction (MD) and the cross-machine direction (CD) by predetermined distances. In the illustrated example, six sources 110 are shown and two rows of multiple detectors 112. In other examples, additional sources 110 and/or detectors 112 may be used. The detectors 112 are separated by a predetermined distance in the machine direction and right and left justified to opposite sides of the frame 102 in the cross-machine direction. In an example, the detectors are two photo-diode arrays (PDA) that are separated by 4″ in the machine direction, and offset to receive the energy from the same sources 110 in the central area of the frame 102 in the cross-machine direction.

Each of the detectors 112 may include individual microsensors 1602, such as photo diodes in a predetermined arrangement or pattern. A single row of microsensors 1602 is illustrated in FIG. 16, however, any number of rows and/or patterns of microsensors 1602 may be used to form the detectors 112. Each of the microsensors 1602 may individually provide a signal to the controller circuitry 142. The controller circuitry 142 may drive the display to visually depict each of the microsensors 1602. Alternatively, or in addition, the microcontrollers 142 may group, combine, or average the microsensors 1602 for representation on the display.

The thickness of the sheet material 122 and the parameters being measured may be factors in determining the configuration and type of detectors and corresponding microsensors 1602 that are chosen. For example, an array shape and type of photo-diode pixels of the photo diode array (PDA) may be chosen for the density measurement and profile display of data for a particular sheet material 122. Pixels from areas that are co-measured on both PDA's may be averaged for an accurate density measurement.

Referring to FIGS. 8 and 16, the detectors 112 of FIG. 16 may represent the detectors 112A-H of FIG. 8 by designating groups of the microsensors 1602 for each of detectors 112A-H. In addition, detectors 112B-112G may be represented by microsensors 1602 in both detectors 112 of FIG. 16 as illustrated by dotted line rectangles in FIG. 16. As discussed with reference to FIG. 8, detectors 112B-112G receive predetermined patterns of energy 602 from neighboring sources 110, and thus both of the two detectors 112 illustrated in FIG. 16 receive energy beams from two different sources.

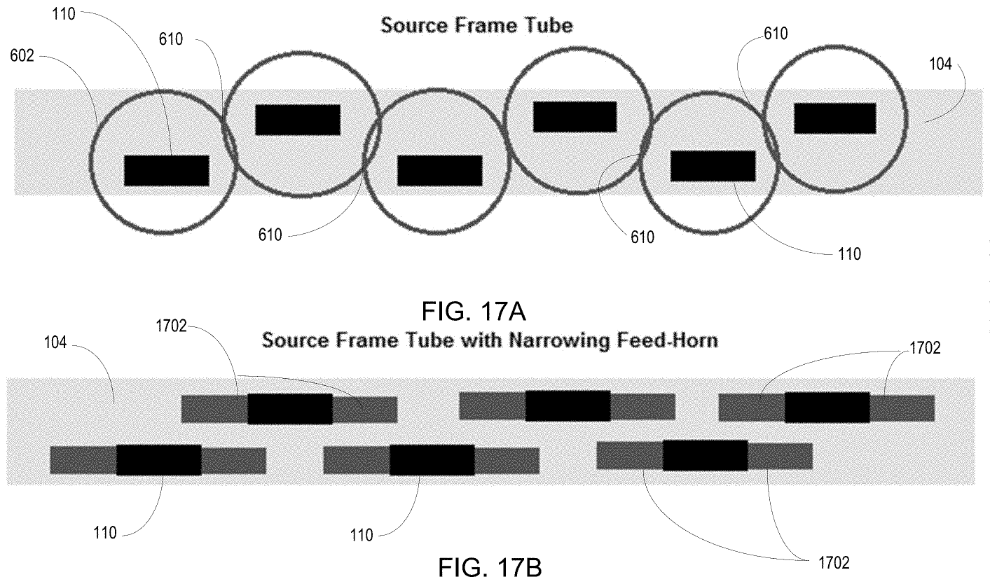

FIG. 17A and 17B are schematics of different example source configurations. In FIG. 17A, similar to FIG. 7, the sources 110 output the predetermined pattern of energy 602 in a generally circular cone shaped pattern that increases in diameter with distance from the sources 110. Thus, overlap points 610 occur at a predetermined distances from the sources 110, which is above the thickest expected height of the sheet material 120.

In FIG. 17B, a predetermined pattern of energy 1702 is provided in a rectangular shape, as illustrated. Thus, there is no overlap points (or cross-over points) as illustrated in FIG. 17A since the predetermined pattern of energy 602 remains substantially the same with distance from the respective sources 110. The term substantially as used to describe the pattern describes disbursement of the energy beam away from the directional travel vector the energy beam was on at the time the beam left the source 110 due to energy distribution factors of the particular source used. In FIG. 17B, the energy output by the sources 110 are controlled by a collimating filter. In an example where the sources 110 are X-ray tubes, the output energy beam may be passed through a mechanical filter in the form of a narrowing feed-horn that blocks the unwanted pattern of energy from being admitted from the tube. In other examples, other types of filters may be used to create a predetermined pattern that avoids overlap or cross over of the energy beams from different sources 110.

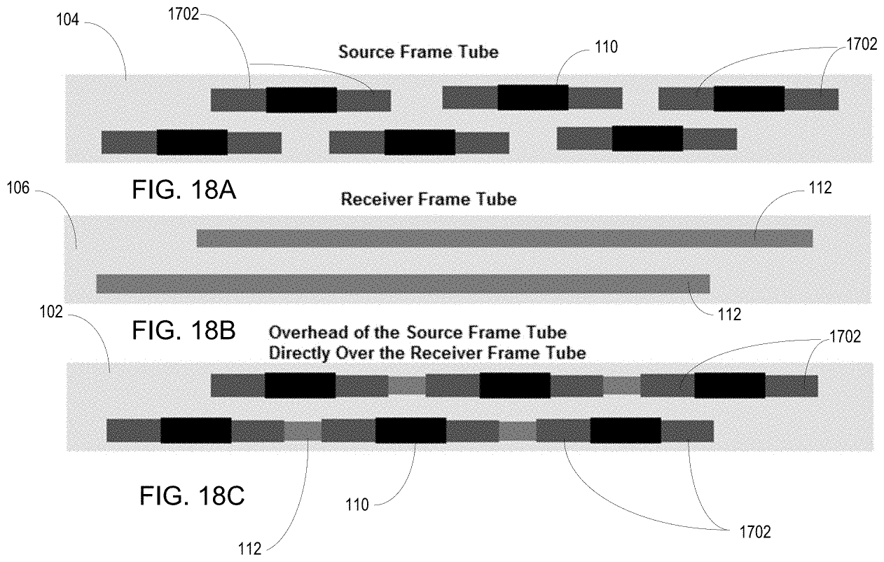

FIG. 18A, FIG. 18B and FIG. 18C are schematic illustrating the first and second rails 104 and 106 from a top view. Similar to FIG. 17B, FIG. 18A illustrates the sources 110 positioned in the first rail 104 and outputting the predetermined pattern of energy 1702 in a generally rectangular shaped pattern that does not substantially increases in area with distance from the sources 110. FIG. 18B, similar to FIGS. 8 and 16 shows the detectors 112 positioned in the second rail 106 to receive energy passing through the sheet material from the sources 110.

FIG. 18C is an example illustrating the predetermined pattern of energy 1702 where the source 110 is shown directly over the detector 112. As illustrated in FIG. 18C, portions of the detectors 112 may not receive the beam of energy from the sources 110 in this configuration. However, since the distance between the sources 110 and the detectors 112 are known and predetermined, the controller circuitry 142 may take this into account when receiving measurement signals from the detectors 112 or simply not have photo-diode pixels of the photo diode array (PDA) receivers in these locations. In other examples where microsensors are used, the controller circuitry 142 may turn off or otherwise minimize the signals from microsensors in areas where detection of the energy beams from the sources 110 are not expected. In other examples, detectors may be physically, electrically or through controller circuitry 142, be omitted in the area of the second rail 106 where energy beams from the sources 110 are not expected to be present.

FIGS. 16-18 illustrate various different example configurations of sources 110, detectors 112, frames 102 and related hardware, and various functionality has been discussed with reference thereto. It should be understood that the configurations and functionality discussed with reference to FIGS. 16-18 is fully interchangeable, useable together or separately useable unless otherwise indicated. Accordingly, the various described configuration and functionality is not limited to the uses described.

Referring to FIGS. 1-18, in an example configuration, the full width measurement system 100 may include sources 110 which are multiple tubes operable as relatively low power x-ray sensor sources to reduce the overall size of the frame 102 and system 100. Since there are multiple x-ray sources, lower energy x-ray sources may be used, which enables a wider range of thickness of materials to be accurately measured. Using multiple tubes can create overlap of energy onto the neighboring detectors, such as groups or arrays of receivers, such as photodiode arrays. In relatively thin sheet materials 122, the magnitude of the energy received by the respective detectors 112 is sufficient to provide accurate measurement. In thicker, or more dense sheet material applications, however, the overlapped energy supplied by multiple sources 110 simultaneously may be needed to pass through the sheet material 122 and reach the detectors 112. Thus, due to the relative lower power x-ray sources, not only is scarce real estate in the production process minimized due to the smaller overall footprint of the frame 102 and related hardware, but also a wider range of thicknesses in sheet materials 122 may be accurately measured, providing greater product manufacturing versatility to product manufacturers using the system 100.

In addition, with the sources 110 operating with x-ray energy, the system 100 may use collimators as the sources 110 to control the x-ray energy to specific areas or a single group of detectors 112. Also, the system 100 may use software to “stitch” the measurement together so as to: A) compensate for areas of material measured by multiple arrays and/or receiving x-ray energy from multiple sources 110; B) Provide a single image of the material for operator viewing; and C) provide an on-going density measurement. Further, the multiple sources and receivers may cooperatively operate to provide calibration of each other.

In an example operation, measurements may be achieved by: 1) exposing a receiver such as a photodiode to x-ray energy from a source through a collimator, to produce an output proportional to the energy received; and 2) measuring the output from the photodiode and performing a mathematical conversion through software, in order to determine the amount of x-ray energy received. The amount of x-ray energy received is primarily the result of product density. Therefore, once the unit is calibrated to known samples, the output of each photodiode can be converted to a density or weight per unit mass measurement. The system also provides a continuous full-width measurement of the product. Important aspects of the design may include:

1. Maintaining constant temperature of the receiver;
2. Performing precise control of the x-ray energy through the collimator design; and/or
3. Precisely placing of the x-ray tubes and photodiode arrays within the frame 102.

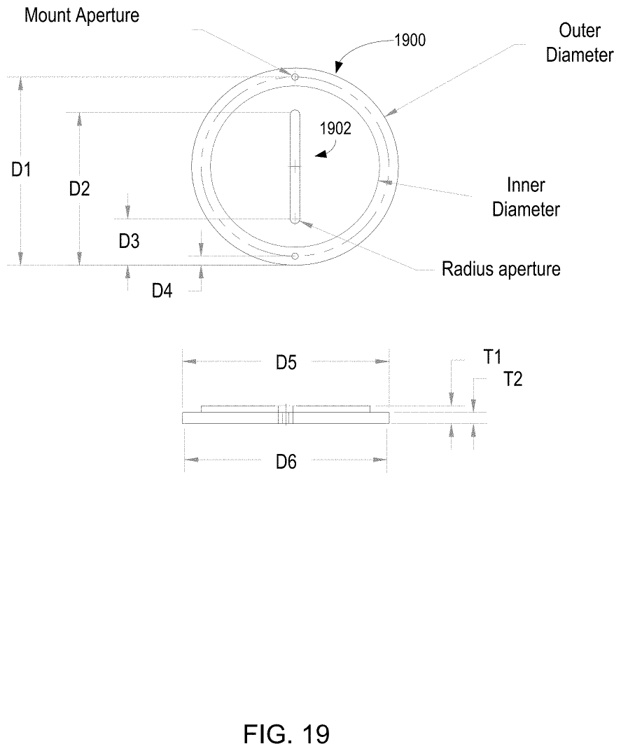

FIG. 19 is an example collimator 1900. In the illustrated example, the collimator 1900 may be circular with a predetermined outer diameter D5 and an inner diameter D6, with the difference between D1 and D2 being a predetermined thickness. The collimator may be formed of a rigid material such as brass. In other examples, the collimator may be square, rectangular, oblong. triangular or any other shape and be formed of other materials. The collimator may house an energy source, such as an X-ray. In other examples, gamma rays, infrared, or any other form of energy capable of penetrating a sheet material being manufactured may be used. The collimator may include an exit aperture 1902 through which energy from the source is emitted. Each collimator 1900 may operate independently to emit energy.

The exit aperture 1902 may be a predetermined shape, such as an oval slot, as illustrated by predetermined distances D1-D4. In other examples, the exit aperture 1902 may be rectangular, or any other shape with predetermined distances. The predetermined distances defining the exit aperture 1902 may be configured to focus and direct the energy from the source to strike or intersect the sheet material in a contact region, which is a predetermined location, a predetermined area, and a predetermined shape on the sheet material being fed past the system. The contact region may dictate the size and shape of the exit aperture. In the illustrated example, the exit aperture 1902 is a radiused slot. That creates an oval cone shaped contact region on the sheet material to be measured 122. The contact regions may be overlapping such that areas of the sheet material are exposed to two different energy sources. The energy from two energy sources in the overlapping regions are received by a detector, and reconciled to create a measurement of the energy level of energy exiting the sheet material. In an example, the energy in the overlapping regions are filtered to a lower energy value, such as by taking an average of two different measurement points. In an example, all or only a portion of the energy detected by the receivers is from the overlapping regions due to the size and shape of the energy received in the contact region. From the energy levels, parameters of the sheet material may be determined, such as the continuous cross-machine direction weight or density measurements as well as a weight and size determination of inclusions. In an example, a weight and size of an inclusion may be determined based on how many pixels are being occupied by an inclusion in a sheet material.

As discussed herein, energy emitted by the collimator may create a predetermined overlapping pattern in the sheet material such that there is an overlapped region and a non-overlapped region. The overlapped region alone may be detected by the receivers. Alternatively, the overlapped region and the non-overlapped regions may be detected by the receivers. Due to the exit apertures and corresponding control of the size and shape of the contact region in which the energy is received, and the predetermined position of the sources, receivers, and materials, in an example, the overlapping and non-overlapping regions may be predetermined and used in the energy level calculations. In other examples, only the overlapping regions, or only the non-overlapping regions may be used in calculation of the energy levels. Such determinations may be determined, for example, based on the thickness of the sheet material.

The sheet material product thickness may be less than the overlap point 610 such that only the overlap energy is received by the receivers. The measurements made by the detectors may be calculated by the system to determine an energy profile for the energy levels passing through the sheet material. The energy profile may be used to calculate a thickness of the sheet material, and a location and depth of inclusions included in the material.

In measurement examples where significant data is collected through the measurements, a portion of the controller circuitry may be at the receiver to avoid transmission speed bottle necks between the detector and the controller circuitry of measurement data. In these examples, only final measurement values may be transmitted to the remainder of the controller circuitry, such as via Ethernet, for further processing and display.

The system 100 includes a communication interface, analysis logic, and a user interface. The communication interface may include one or more Ethernet ports, or any other type of wired or wireless communication interface. The communication interface receives packets that include annotation information. These packets may be generated by external communication systems.

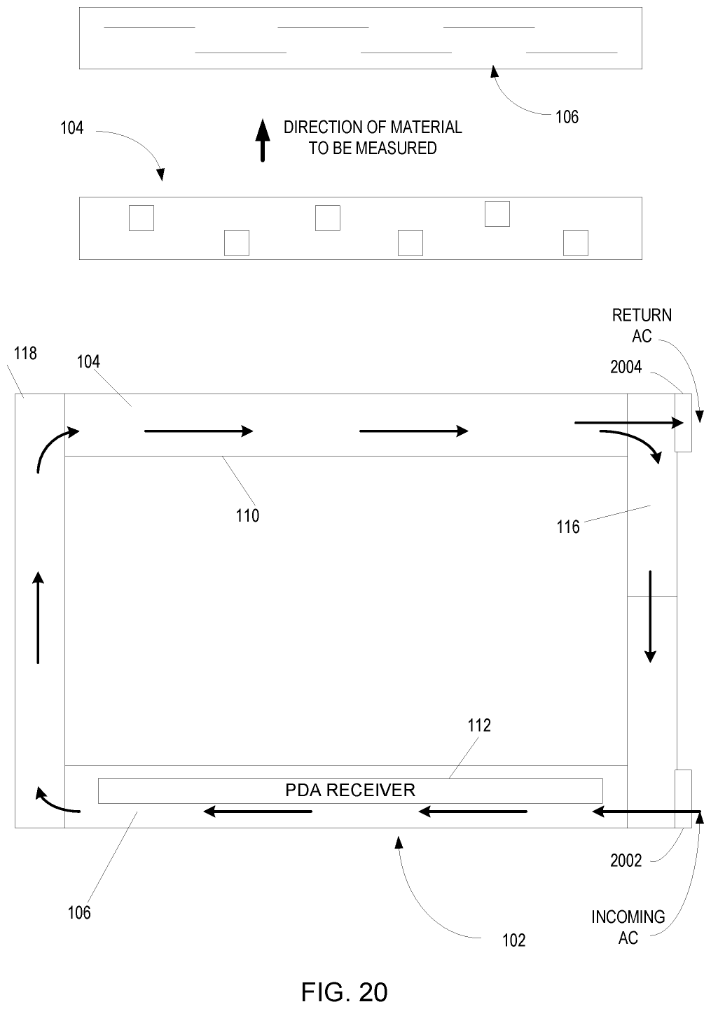

FIG. 20 depicts an example of a detector configuration 112, a source configuration 110 and a cooling system. The cooling system provides air conditioning (AC) both to cool and to provide a positive pressure within the frame 102 to minimize debris within the system 100. In the illustrated example, the top rail 104 and the bottom rail 106 are coupled together by end columns 116 and 118, and a source of pressurized air 2002 is provided to an air inlet 2004 included in the bottom rail 106 such that air supplied from the air inlet 2004 flows through the bottom rail 106, the end column 118 and out an air outlet 2006 included in the top rail. In this example, the controller circuitry 142, may, for example, be at least partially disposed in the end column 118.

The functionality and/or logic of the system 100 described herein may be implemented in hardware, software, or both. In one implementation, the functionality and/or logic includes one or more processors and memories. The memory may store analysis instructions (e.g., program instructions) for execution by the processor. The memory may also hold operational parameters.

The system circuitry may include one or more processors and memories. The memory stores, for example, control instructions that the processor executes to carry out desired functionality for the system. Control parameters may provide and specify configuration and operating options for the control instructions included in the system. For instance, the control instructions and control parameters may implement analysis of the sensor data for the material received by the receiver. The memory may also store any BT, WiFi, cellular, or other transceiver data sent or received, through the communication interfaces.

The system may receive network data through the networks including, e.g., the Internet, or other LAN/WAN networks whether private or public. Similarly, the system may transmit network data through the networks to many different destinations. Examples of sources and destinations include file servers; communication satellites; computer system; network devices such as switches, routers, and hubs; and remote databases.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

Various implementations have been specifically described. However, many other implementations are also possible.

What is claimed is:

1. A full width measurement system comprising:
a frame comprising a first rail and a second rail, the first and second rails positioned transverse to a moving sheet of material such that the first and second rails are positioned on opposite sides of the moving sheet;
a plurality of sources positioned along the first rail in a predetermined arrangement across a width of the moving sheet, each of the sources configured to emit energy toward the moving sheet in a predetermined pattern;
a plurality of detectors positioned along the second rail in a predetermined alignment with respect to the sources such that each of the detectors detect an energy level from multiple respective sources after the energy from the respective sources has passed through the moving sheet; and
a controller circuitry configured to receive signals from the detectors and provide real time measured parameters spanning the width of the moving sheet of material.

2. The full width measurement system of claim 1, wherein the predetermined pattern of energy from each of the respective sources is emitted in a cone shaped pattern of increasing diameter with distance from a respective source, and the detector is positioned a predetermined distance from the moving sheet of material such that respective cone shaped patterns of energy emitted from the sources are overlapping at the detectors.

3. The full width measurement system of claim 1, wherein the controller circuitry is configured to generate a full width measurement of the moving sheet in real time based on the signals received from the detectors.

4. The full width measurement system of claim 3, wherein the controller circuitry is further configured to detect multiple inclusions anywhere across the width of the moving sheet.

5. The full width measurement system of claim 1, Wherein the controller circuitry is configured to receive the signals from the detectors in a serial stream of data representative of snapshots across the width of the moving sheet such that the controller circuitry generates a continuous full sheet image representing the moving material passing between the sources and the detectors.

6. The full width measurement system of claim 1, wherein the controller circuitry is configured to identify at least one of a weight, or a size, or both a weight and a size, of an inclusion included in the moving sheet.

7. The full width measurement system of claim 1, wherein the controller circuitry is configured to identify an inclusion having at least one of a weight, or a size, or a combination thereof, based on a predetermined threshold.

8. The full width measurement system of claim 7, wherein the predetermined threshold is a user entered value.

9. The full width measurement system of claim 7, wherein the threshold comprises a plurality of different parameters.

10. The full width measurement system of claim 1, wherein each of the detectors are photo diode arrays comprising a plurality of sensors, each of the sensors configured to output one of the signals, each of the signals representative of a measurement location on the moving sheet.

11. The full width measurement system of claim 1, wherein the first rail is a top rail positioned above the moving sheet, and the second rail is a bottom rail positioned below the moving sheet.

12. A measurement system comprising:
a controller circuitry configured to output a display image indicative of a measurement across a width of a moving sheet of material;
a plurality of sources arranged across the width of the moving sheet and controlled by the controller circuitry to selectively emit energy toward the moving sheet; and
a plurality of detectors arranged across the width of the moving sheet to detect a level of the energy emitted by the sources and passing through the moving sheet, each of the detectors in electrical communication with the controller circuitry to provide a signal indicative of a measurement of a portion of the width of the moving sheet of material, and the controller circuitry configured to output the display image in accordance with the signal received from each of the detectors.

13. The measurement system of claim 12, wherein the detectors are positioned a predetermined distance from the detectors and the moving sheet of material passes between the sources and the detectors such that predetermined shaped patterns of energy overlap at a time when the energy reaches the moving sheet.

14. The measurement system of claim 12, wherein the detectors may be positioned across the width of the sheet to provide at least two measurements for each of a plurality of predetermined locations across the moving sheet.

15. The measurement system of claim 14, wherein the controller circuitry is configured to determine a depth of an inclusion in the moving sheet using the at least two measurements.

16. The measurement system of claim 12, wherein the sources each include a collimator, the collimator comprising a slot from which the energy is emitted, the slot having a length greater than a width, the length of the slot longitudinally extending across a portion of the cross directional width of the moving sheet.

17. The measurement system of claim 12, wherein the sources and the detectors are arranged in a plurality of rows along a top rail and a bottom rail, respectively, transverse to the sheet, wherein the sources in different rows are positioned in serially discrete positions with respect to a machine direction of the moving sheet, and the detectors in different rows are staggered in an overlapping positions with respect to the machine direction of the moving sheet.

18. A computer readable medium configured to store a plurality of instructions executable by controller circuitry, the computer readable medium comprising:
instructions executable by the controller circuitry to control a plurality of sources serially positioned across a width of a moving sheet of material, the sources controlled by the controller circuitry to cooperatively emit energy;
instructions executable by the controller circuitry to receive a plurality of measurement signals from a plurality of respective detectors positioned across the width of the sheet, the measurement signals indicative of a level of the energy from the sources passing through the moving sheet of material for receipt by the detectors;
instructions executable by the controller circuitry to direct generation of an image on a display device, the image representative of a compilation of the measurement signals and depicting measurement of an entirety of the width of the moving sheet representative of a cross-directional measured area of the moving sheet.

19. The computer readable medium of claim 18, wherein the detectors comprise a plurality of sensors in an array, and the instructions executable by the controller circuitry to receive the measurement signals from the respective detectors comprises instructions executable by the controller circuitry to receive a dataset of measurement data from each of the sensors that is synchronized such that the dataset is representative of the cross-directional measured area across the width of the moving sheet.

20. The computer readable medium of claim 19, wherein the instructions executable by the controller circuitry to receive the measurement signals from the respective detectors further comprises instructions executable by the controller circuitry to receive a plurality of datasets sequentially in time such that the plurality of datasets represent a plurality of different cross-directional measured areas disposed sequentially along a length of the moving sheet in a machine direction of movement of the moving sheet.
